(19) United States
(12) Patent Application Publication
(10) Pub. No.: US 2011/0148150 A1
(43) Pub. Date: Jun. 23, 2011

(54) PILLAR COVER WITH INTEGRATED FIXING AID

(76) Inventors: Ralf Gerndorf, Finnentrop (DE); Jochen Schulze Zur Wiesche, Koln (DE); Norfried Bittner, Witten (DE); Axel Nusken, Altena (DE); Martin Schulte, Balve (DE)

(21) Appl. No.: 12/823,020

(22) Filed: Jun. 24, 2010

(30) Foreign Application Priority Data
Jun. 29, 2009 (DE) 10 2009 026 070.6

(51) Int. Cl. B62D 25/04

(52) U.S. Cl. 296/193.06

(57) ABSTRACT

The invention relates to a pillar finisher, which is connected by fastening means with the side post of a vehicle body. For fastening, dowel-like fixing aids are provided which penetrate the body sheet of the vehicle body in the intended final installed state and engage behind the vehicle body or lie in clamping against the body sheet. In order to make possible a simple mounting of the pillar finisher on the vehicle and in order to reduce the number of parts, provision is made that the fixing aids are produced as an integral component of the pillar finisher.

### CROSS-REFERENCE TO RELATED APPLICATIONS

The present application claims priority to German Patent Application Serial No. DE 10 2009 026 070.6 filed on Jun. 29, 2009, the entire contents of which are incorporated herein by reference.

### STATEMENT RE: FEDERALLY SPONSORED RESEARCH/DEVELOPMENT

Not Applicable.

### BACKGROUND

The invention relates to a pillar finisher which is arranged to be connected with a vehicle body by fastening means, wherein the fastening means comprise dowel-like fixing aids which at least partially penetrate the body sheet of the vehicle body in the intended final installed state, and engage behind the body sheet or lie clamping against the body sheet in the region of the penetration, to support a holding force.

### BRIEF SUMMARY

Pillar finishers of this type are generally known in automotive engineering. They are used in particular to conceal bodywork gaps or functional parts in the region of the door and side window, and also particular surfaces of the body in the region of the doors and side windows which are not intended to form any visible areas which are detectable from the exterior. In addition, they serve to receive and to hold functional parts—seals, for example.

It is known to screw the pillar finishers to the vehicle body, with dowel-like fixing aids being used for the screwing, which are inserted into fastening openings in the body sheet provided for this, before the actual final mounting of the pillar finisher, in order to ensure a permanent and secure holding of the screws. Such a fastening of a pillar finisher is shown in the European published application EP 1 584 517 A2.

A disadvantage in this type of pillar finisher fastening are, however, the number of individual parts which are to be used and the assembly costs connected therewith. Before the final mounting of the pillar finisher, firstly a dowel-like fixing aid is to be inserted into each of the fastening openings which are provided for this in the vehicle body. Only then can the pillar finisher be fastened on the body, wherein the latter is firstly to be placed by the technician precisely in the correct mounting position on fastening, due to the lack of pre-alignment of the pillar finisher, in order to bring the through-holes in the pillar finisher and the fastening openings in the vehicle body to congruence.

The assembly times on the assembly line have become an important cost factor, and every even small simplification of assembly and every even small minimizing of the assembly times is an important influencing factor in a decision for or against the introduction of a new component.

In addition, with regard to logistical aspects, is the fact that further drawings have to be prepared and parts numbers have to be arranged and carried for each individual part, that the assembly lines are to be supplied with a greater number of parts and that a greater number of replacement parts have to be held. The greater the number of parts, the greater is the overall logistical complexity and the liability to error in the production process which this entails. The reduction of the number of parts is therefore also a quality factor.

It is an object of the invention to design a pillar finisher of the type described in the introduction such that its mounting can be brought about as quickly and in as uncomplicated a manner as possible. At the same time, the number of required components which are to be handled by the technician on the assembly line and which are to be included logistically and documented, should be kept as low as possible.

This problem is solved according to the invention in that the fixing aids are an integral component of the pillar finisher, in particular are embodied in one piece with regard to material with the pillar finisher.

The designated solution to the problem ensures that the pillar finisher together with the fixing aids is present as a single component and accordingly only a single component is to be handled by the fitter. Through the fact that the positioning of the fixing aids on the actual pillar finisher corresponds to the arrangement of the fastening openings in the body sheet, the pillar finisher can be placed particularly quickly and simply against the vehicle body and positioned correctly immediately.

The expression “in one piece with regard to material” means that the fixing aids and the pillar finisher not only form a cohesive assembly group, as can also be the case within a pre-assembly of two components, but also that the fixing aids form an integrated, inseparable component of the pillar finisher. Preferably, provision is made that the fixing aids are formed on the pillar finisher or are injected onto the pillar finisher in the same manufacturing step as the pillar finisher, in particular in the same injection molding process, and hence with the same tool.

For the sake of completeness, it is to be mentioned that the expression “vehicle sheet” with regard to the vehicle body of course not only refers to steel materials, but also other materials are to be comprised here, which are basically suited to the manufacture of a vehicle body, for example plastics, fiber-reinforced plastics and other composite materials.

In order to ensure that the pillar finisher is held securely and permanently on the vehicle body, the fixing aids are preferably formed by clamping wings, lying opposite each other, which are constructed to receive a spreading element between them in the intended final installed state. In the simplest case, the spreading element is a screw, a rivet or a spreading pin. The expression “spreading element” does not necessarily mean here that it spreads the clamping wings apart such that their ends move away from each other. The determining factor, rather, is that the spreading elements reliably prevent an inward bending of the clamping wings in the intended final installed state. In addition, they are intended to ensure a sufficient clamping force. However, spreading elements can of course also be provided, which on introduction between the clamping wings drive these apart such that the fixing aids are deformed and are squeezed with the body sheet in the region of the fastening openings.

In order to be able to introduce the fixing aids better into the fastening openings, provision is preferably made that the effective outer contour of the fixing aid, formed by the clamping wings, widens initially, starting from the end of the fixing aid facing away from the inner side of the pillar finisher. The fixing aid thereby largely centers itself on placement against the body, the mounting process takes place more quickly and more unproblematically.

In a further preferred embodiment, provision can be made that a holding projection, engaging in a form-fitting manner behind the vehicle body in the intended final installed state, is constructed on the clamping wings of the fixing aid. This embodiment provides for a particularly secure hold of the pillar finisher on the body, because even with a low clamping force, the form fit ensures a fastening which with the use of suitable spreading elements can not be detached in a non-destructive manner.

In order to arrange the assembly so as to be even simpler for the production technician, provision can be made that the fastening means comprise spreading elements which after the placement of the pillar finisher onto the vehicle body are able to prevent an inward bending of the clamping wings, wherein the spreading elements are pre-mounted on the pillar finisher. Here, the spreading elements in the pre-mounted state should of course only project into the fixing aid to such an extent that they (still) do not project between the clamping wings, so as not to prevent the mounting of the pillar finisher. First and foremost, the pre-assembly of the spreading elements leads to the fitter not having to grasp and place the spreading elements separately, but rather that he only has to transfer them into the final installed position after the placement of the pillar finisher with the aid of a corresponding tool. This also leads to a shortening of the assembly times.

It is regarded as particularly advantageous if the clamping wings are constructed such that they bend in resiliently on placement of the pillar finisher onto the vehicle body. The clip-like engagement, connected herewith, into their final installed position signals to the fitter the correct seat of the pillar finisher on the body. If such an engagement is absent, the fitter will make sure that the pillar finisher is sitting correctly on the body, in order to rule out an incorrect assembly. Through the quality assurance which is achieved hereby, assemblies which are carried out incorrectly are practically eliminated. However, provision can also be made that the clamping wings are inclined towards each other to simplify the introduction in fastening openings, and only the introduction of a spreading element urges the clamping wings into their final installed position and, in so doing, squeezes them with the body sheet.

Preferably elastic intermediate elements are provided in the region of the fixing aids and between the surfaces of the pillar finisher and of the vehicle body, lying against each other or lying immediately opposite each other. Depending on the material properties, these can serve both as a seal, preventing the penetration of moisture through the fastening openings into the vehicle body, and also form a tolerance compensation which pre-stresses the components with respect to each other and counteracts a gradual decrease of the connecting forces between the pillar finisher and the vehicle body, which can occur in the course of the operating time due to continuous vibrations and other stresses. The tightness of the body posts towards the exterior is thus guaranteed and a rattling of the pillar finisher occurring during the operating time is prevented.

In order to satisfy both the visual requirements for the pillar finisher, which naturally has an outwardly-directed exposed surface, which has a not insignificant influence on the appearance of a vehicle, and also to satisfy the mechanically functional requirements for the material of the pillar finisher with regard to its connection with the body, provision can be made that the pillar finisher, to form the exterior exposed surface, is formed on the outer side by an exposed plastic with a first material characteristic and on the inner side by a functional plastic with second material characteristics different from the first material characteristics, wherein in particular the region of the pillar finisher forming the fixing aids is formed by the functional plastic.

The background to this consideration is that the visually influential exterior is preferably to be formed by a very hardwearing, weather- and UV-resistant and scratch-proof exposed plastic, which is also intended to imitate in particular glass or metal surfaces. Plastics with these characteristics are, however, brittle and therefore regularly break with the bending, torsional and squeezing stresses entailed by a pillar finisher installation, in particular the introduction of a spreading element. The introduction of the spreading elements is also more difficult to bring about, because greater forces are to be applied for this. Therefore, the material region of the pillar finisher facing the vehicle body, on which the functional components, for example the fixing aids, are constructed, is preferably formed from a functional material which has the characteristics which are necessary for the secure and permanent fastening of the pillar finisher. Plastics are to be considered in particular here which are softer, tough and deformable in the required limits.

The manufacture of such a multi-layered pillar finisher preferably takes place in a multi-component injection molding process, in which after the injection of the first layer by drawing of a mould core or by the freeing of a further tool volume, the second material is subsequently injected and fits securely against the first material and connects itself securely therewith.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a three-dimensional overall view of a pillar finisher with fixing aids arranged thereon;

FIG. 2a shows a detail view of the region of the pillar finisher of FIG. 1, on which the fixing aid is constructed;

FIG. 2b shows the detail view of FIG. 2a with inserted spreading element;

FIG. 3 shows an illustration of the pillar finisher in section with introduced spreading element and additionally held functional parts; and

FIGS. 4a to 4c show a diagrammatic illustration of the placement and fastening of a pillar finisher onto the vehicle body within the assembly.

### DETAILED DESCRIPTION

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

In FIG. 1 a pillar finisher 1 is illustrated in a perspective overall view, which shows in particular the inner side of the pillar finisher. The pillar finisher illustrated in FIG. 1 is a plastic component produced by injection molding.

A first side edge of the pillar finisher 1 has in the end region a holding web 8, constructed in a U-shape and angled through approximately 90°, which in the installed state engages behind the body sheet of a vehicle body forming the outer edge of a side post. On the opposite, second side edge, a fixing web 9 is constructed, which is intended to be fastened to the vehicle body by fastening means. On the fixing web 9, fixing points are formed at intervals from each other, on which fixing aids 2 are provided in the form of a fastening clip, which form an integral component of the pillar finisher 1.

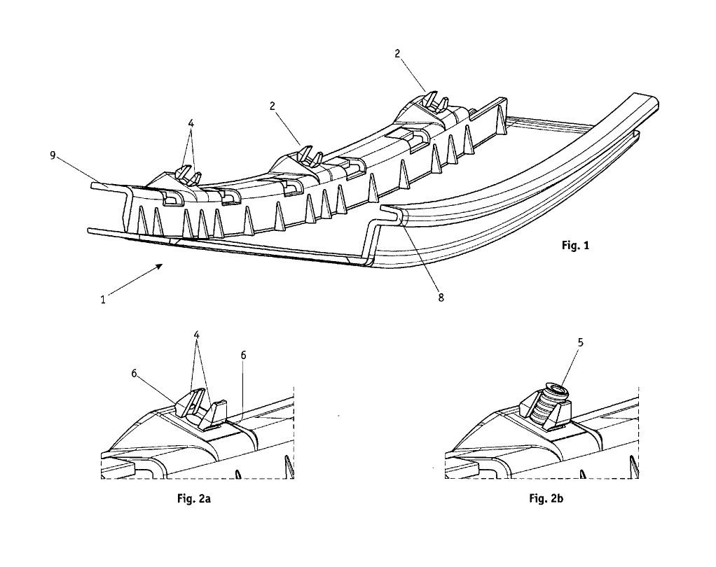

The fixing aids 2 have dowel-like extensions in the form of two clamping wings 4, the inner surfaces of which, facing each other, run as much as possible parallel, whereas the outer surface, proceeding from the end facing away from the inner surface of the pillar finisher 1, initially widen in a wedge shape, to narrow again after approximately two thirds of the length of the clamping wing. The inner sides of the clamping wings 4 additionally form depressions, which follow the generated surface of an imaginary cylinder situated between the clamping wings and which, as shown in particular by the detail drawing of FIGS. 2a and 2b, simplify the reception of a spreading element 5 and present a greater contact surface for its thread, cutting into the material of the clamping wings 4.

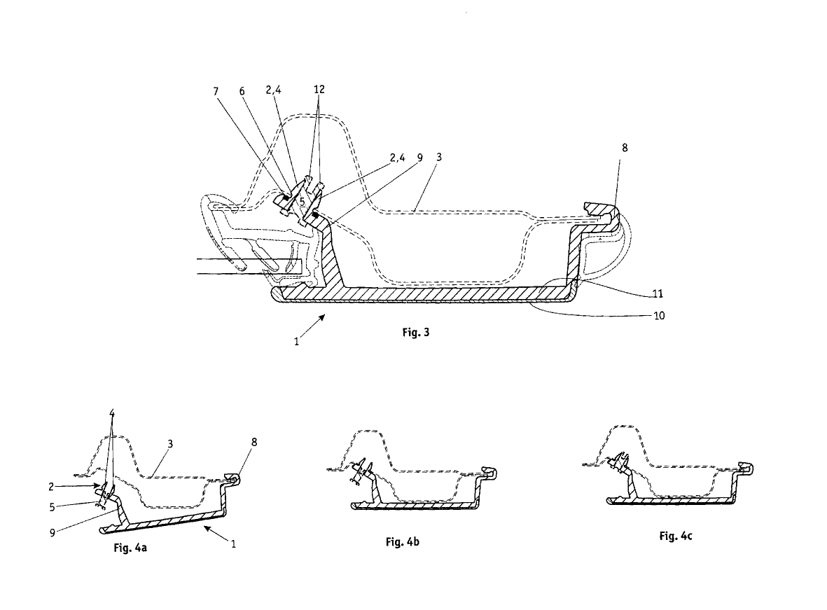

The fixing aids 2 penetrate the body sheet in the assembled state and project into the side post of the body, as can be seen in detail in FIG. 3. FIG. 3 and FIG. 2b illustrate that despite the outer wedge surfaces provided on the clamping wings 4, with the inserted spreading element no possibility exists for the wedge surfaces to bend inwards, so that a secure hold is ensured on the body post and a removal of the pillar finisher 1 from the body post is not possible.

In FIG. 3 it can be seen that the fixing aid 2 is connected with the pillar finisher 1 so as to be in one piece with regard to material. The tool cavity forming the fixing aid 2 in the injection molding process is molded in the same injection molding tool with which the pillar finisher 1 is also created.

The pillar finisher 1 illustrated in FIG. 3 is, in addition, constructed in a multi-layered manner. On the outer side, i.e. on the surface pointing away from the vehicle, the pillar finisher 1 is formed by an exposed plastic layer 10. In the assembled state, this forms the surface influencing the visual impression, which from aesthetic considerations is intended to make as high-quality an impression as possible over the entire lifetime of the vehicle, and therefore is produced rather from hard, scratch-proof plastics. The inner layer of the pillar finisher 1, which points towards the vehicle post and in the assembled state of the pillar finisher is not visible from the exterior, is formed from a functional plastic layer 11. The plastic used for this layer requires material characteristics which do not readily reconcile with those required for the exposed plastic layer. The functional plastic layer 11 is therefore produced with a plastic which rather has ductile or viscoplastic characteristics. As can be seen from FIG. 3, the fixing aids are a component of the functional plastic layer. They are preferably molded in the same injection molding process and cool down as part of the functional plastic layer together with the latter.

FIGS. 4a to 4c show diagrammatically how the pillar finisher 1 is placed onto the vehicle post. Firstly, the pillar finisher 1 is placed with the holding web 8 onto the body such that the holding web 8 embraces the outer edge of the post (FIG. 4a). The pillar finisher 1 is then pivoted through approximately 10° in the direction of the body post and the fixing aids 4 are brought into congruence with the fastening openings in the body post (FIG. 4b). For this, the pillar finisher 1 is still displaceable in certain limits in this position in a vertical direction. Once in the correct position, the pillar finisher only has to be clipped onto the body post by light pressure. The force necessary for this should be sufficiently small, by a corresponding dimensioning of the fixing aids and a suited choice of material, to not exhaust in the long run or to make a handling necessary entailing great forces, possibly damaging the material. At the same time, the assembly resistance should be sufficiently high to be able to indicate its being overcome to the assembly worker by engagement of the fixing aids. Following the engagement of the fixing aids, the pillar finisher 1 can finally be fixed by the introduction of the spreading elements (FIG. 4c).

The advantages of the embodiment of the pillar finisher 1 become particularly clear with the aid of FIGS. 4a to 4c. The technician carrying out the assembly only has to handle a single part. The insertion of separate fixing aids 2 into the fastening openings in the body sheet 3 provided for this, which is usually to be carried out before the assembly step of FIG. 4a, is dispensed with entirely. After the pivoting in of the fixing aid 2 into the position shown in FIG. 4b, the vertical alignment of the pillar finisher 1 is conceivably able to be brought about in a simple manner, because the fixing aids 2, once in the correct position, sink slightly into the fastening openings owing to their end tapering in a wedge shape, so that already before the actual clipping in of the pillar finisher 1 onto the body, the correct positioning is discernible for the fitter. A further advantage is that after the engagement of the fixing aids 2, the fitter no longer has to keep hold of the pillar finisher 1, so that he has both hands free for the further assembly steps. On introduction of the spreading elements 5, he therefore does not have to keep hold of the pillar finisher.

It is also worth mentioning in particular that the spreading elements 5, as shown by FIG. 4a and FIG. 4b, are already pre-mounted on the pillar finisher 1. This also simplifies and accelerates the assembly process considerably, because the spreading elements 5 do not have to be handled separately by the fitter. The spreading elements 5 have resiliently acting clamping jaws 12 on the preceding end on introduction into the fixing aids 2, for fixing on the pillar finisher 1, which clamping jaws 12 hold the spreading element 5 securely in position up to the final assembly, although it is not yet fully introduced between the clamping wings 4 of the fixing aid 2. The pre-mounted spreading elements 5 project here only so far into the fixing aid 2 that the elasticity of the clamping wings 4, necessary for the simple but palpable engagement of the fixing aid 2, is not impaired. The slight bending of the clamping wings 4 inwards which is necessary for this is therefore not prevented by the spreading elements 5.

After the pressing in of the spreading elements 5 between the clamping jaws 4, the projecting outer edges of the clamping jaws 12, which protrude outwards in the manner of a bead, embrace the ends of the clamping wings 4 of the fixing aid 2 in a resilient manner, which ensures an additional hold for the spreading elements 5. The spreading elements 5 therefore engage in their final position in a manner which can be detected by the fitter, which signals to him that they are sitting correctly. In particular, it can be ensured in this way that the simple axial pressing in of the spreading elements 5 between the clamping wings 4 is sufficient for the final fixing of the pillar finisher 1 on the body. The turning of the spreading element 4, which is necessary with screwing, can be dispensed with, which not only guarantees a quicker and simpler assembly, but also makes possible the use of simple hand tools. The spreading elements 5 are preferably made from a plastic.

1. The pillar finisher, arranged in order to be connected by fastening means with a vehicle body, wherein the fastening means comprise at least one dowel-like fixing aid which at least partially penetrate the body sheet of the vehicle body in the intended final installed state and in the region of the penetration, to support a holding force, engage behind the body sheet or lie clamping against the body sheet, comprising:
fixing aids which are an integral components of the pillar finisher, and are embodied so as to be in one piece with the pillar finisher with regard to material.

2. The pillar finisher according to claim 1 wherein the fixing aids are formed by clamping wings lying opposite each other, which are constructed to receive a spreading element between them in the intended final installed state.

3. The pillar finisher according to claim 2 wherein the effective outer contour of the fixing aid widens initially, starting from the end facing away from the inner side of the pillar finisher.

4. The pillar finisher according to claim 3 wherein a holding projection is constructed on the clamping wings of the fixing aid, engaging in a form-fitting manner behind the vehicle body in the intended final installed state.

5. The pillar finisher according to claim 4 wherein the fastening means comprise spreading elements, wherein the spreading elements are pre-mounted on the pillar finisher.

6. The pillar finisher according to claim 5 wherein the clamping wings are constructed such that they bend in a resilient manner on pressing into the fastening openings provided in the vehicle body.

7. The pillar finisher according to claim 6 wherein the clamping wings are inclined towards each other, to simplify the introduction in fastening openings, and only the introduction of a spreading element urges the clamping wings into their final installed position.

8. The pillar finisher according to claim 7 wherein elastic intermediate elements are provided in the region of the fixing aids and between the surfaces of the pillar finisher and of the vehicle body lying opposite each other.

9. The pillar finisher according to claim 8 wherein to form the outer exposed surface, the pillar finisher is formed on the outer side by an exposed plastic having first material characteristics and on the inner side by a functional plastic having second material characteristics which are different from the first material characteristics.
